(19) United States
(12) Patent Application Publication
(10) Pub. No.: US 2012/0185130 A1
(43) Pub. Date: Jul. 19, 2012

(54) Vehicle lighting

(76) Inventors: Gregory J. Ekchian, Belmont, MA (US); Jack A. Ekchian, Belmont, MA (US)

(21) Appl. No.: 13/374,850

(22) Filed: Jan. 18, 2012

Related U.S. Application Data
(60) Provisional application No. 61/461,442, filed on Jan. 18, 2011.

(51) Int. Cl. G06F 7/00

(52) U.S. Cl. 701/36

(57) ABSTRACT

A vehicle lighting system is provided where the signal lights are configured so that their performance may be adapted based on ambient conditions and operational requirements. The signal lights are controlled to improve their effectiveness and efficiency.

### CROSS-REFERENCE TO RELATED APPLICATIONS

This application claims priority of U.S. Provisional Patent Application No. 61/461,442, filed Jan. 18, 2011, entitled “System for Improved Vehicle Lighting,” the contents of which are hereby incorporated herein by reference in their entirety.

### FIELD OF INVENTION

The present invention generally relates to vehicle signal lighting. In particular, it relates to a method and apparatus for using adaptable signal lights to improve visibility, effectiveness and efficiency of such lighting.

### BACKGROUND OF INVENTION

Vehicles are typically configured with various lights placed at a number of locations on the exterior of the vehicle or interior lights which can be observed from outside the vehicle. Such lights include, for example, headlights whose main function is to illuminate the road ahead. Headlights need to be bright enough at night so that drivers can drive safely. Some modern vehicles are configured to turn on such headlights automatically when it gets dark.

Other types of lights commonly used in vehicles are signal lights and include both stationary and rotating emergency lights. Examples of emergency lighting systems are disclosed in U.S. Pat. Nos. 3,789,358; 4,357,595; 5,884,997 and 6,100,791, the contents of which are incorporated herein by reference in their entirety.

Signal lights are typically used to communicate information to other drivers such as, for example: hazard warning lights that indicate the existence of imminent danger, a slow moving vehicle or other unusual vehicle operation; turn signal lights that indicate the intention to make a turn; brake lights which indicate that the brakes have been applied; backup lights that indicate that the transmission is in reverse gear; and red or blue emergency lights that identify the vehicle type.

Some of these lights may be visible only from the rear of the vehicle while others may be visible from the front. Certain colors are typically used for particular signal lights. For example, in certain jurisdictions, red or blue emergency lights impose legal obligations on drivers, such as the requirement to pull over to the side of the road to allow an emergency vehicle to pass. Typically red is used for brake lights, white for backup lights and amber or red for turn signals. Signal lights need to be effective both during daylight hours as well as at night.

Unfortunately, certain signal lights such as, for example, strobe lights and rotating emergency lights on certain commercial or emergency vehicles are so bright that at night they obscure the presence of pedestrians and objects in the vicinity of such vehicles. They provide sufficient light at a sufficient intensity so that they are easily visible in bright sunlight. The light level outdoors on a bright sunny day is approximately 100,000 lux while on a dark night, it may be over eight or nine orders of magnitude lower.

For example, at night drivers approaching a stopped police car that has its emergency lights turned on are frequently unable to see police officers walking in the vicinity of the police car because the officer's presence is masked by the bright emergency lights. The intense direct light from these lights overwhelms the reflected light that reaches a driver's eyes. Occasionally the problem is compounded by the presence of multiple emergency vehicles, for example at the scene of an accident at night. The presence of a wide array of flashing and turning bright red and blue lights on several vehicles can obscure the presence of emergency personnel, other pedestrians, disabled vehicles, and other obstructions, aggravating an already dangerous situation.

Frequently, when a vehicle is traveling on a highway at night, the brightness and persistent flashing of hazard flashers or emergency lights may detract from the effectiveness of other signal lights such as the brake lights or turn signals. A driver approaching a vehicle with hazard lights, strobe lights or other warning lights flashing may not be able to immediately perceive or may miss altogether that the brake lights have been illuminated. Cars on highways frequently travel at speeds in excess of 100 feet per second. It is, therefore, critical that drivers recognize as quickly as possible that the brake lights of a vehicle in front of them have been illuminated. A delay of even half a second can result in a vehicle traveling an extra 50 feet or more and could easily result in a serious accident.

Certain signal lights may have multiple uses. For example, the same lights are typically used as 4-way hazard warning lights in cars as well as turn signal lights. Typically, the flashing frequency, illumination and other parameters of signal lights being used to indicate a turn signal are indistinguishable from those used to indicate a hazard warning signal. Copending application Ser. No. 12/181,879, entitled Turn Signals Generated During Operation of Vehicle Hazard Warning Lights, the contents of which are incorporated herein by reference in their entirety, discloses the use of different frequencies, brightness and duty cycles to differentiate a turn signal from a simultaneously given hazard signal.

### SUMMARY OF THE INVENTION

It is an object of this invention to adjust the operation of signal lights based on the vehicle environment and operating requirements. For example, the appearance or operating parameters of one or more vehicle signal lights may be adjusted based on prevalent conditions, such as, for example, ambient light level, vehicle speed, time of day, and operator commands. For example, the color, intensity, flashing frequency or shape of the illuminated region of signal lights may be varied.

It is a further object of this invention to use a single light for multiple purposes by changing its operating parameters including, for example, color, illumination intensity, and flashing frequency. Changing appearance or other operating parameters may be based on environmental conditions including ambient light level or weather conditions as well as the actions of the vehicle operator. For example, if the turn signal lever of a vehicle is put in a left turn position while hazard flashers are operating, the shape of the illuminated region of the left turn signal may be altered to convey a simultaneous turn signal and hazard warning.

It is still another object of this invention to utilize flexible multi-purpose signal lights. The lighting system may be configured so that, for example, all available rear facing lights act as brake lights during rapid braking from high speeds. For example, in a police vehicle when the brakes are applied to slow the vehicle from a high speed, lights such as, for example, normally blue strobe lights and rotating lights and white backup lights may be illuminated in red. Under such circumstances, the rotating lights may be held in a fixed position.

Alternatively, when the vehicle is backing up where there is very little ambient light, the backup lights are augmented by illuminating turn signals and brake lights and causing them to produce white light.

It is further the object of this invention to establish a hierarchy among signal lights. For example, certain signal lights such as turn signal lights may be considered more important than, for example, hazard lights or rotating police lights. The operation of signal lights of lower priority may be interrupted during the operation of higher priority signal lights. Alternatively, lights at a lower priority level may be dimmed when higher priority lights are activated. For example, when the brakes are applied, the brake lights may be illuminated at full intensity, while other signal lights (such as hazard lights, strobe lights, rotating police lights) may be dimmed or extinguished altogether. The operation of such lights may then be allowed to return to their previous state after a predetermined period while the brakes are still being applied or after the brakes are released.

### BRIEF DESCRIPTION OF DRAWINGS

FIG. 1 shows a schematic of a circuit for controlling exteriorly visible lights of a vehicle configured according to an embodiment of the invention.

FIG. 2 shows a schematic of a circuit for controlling exteriorly visible multipurpose lights of a vehicle according to another embodiment of the invention.

FIG. 3 shows a schematic representation of flashing left and right hazard warning lights.

FIG. 4 shows a schematic representation of flashing left and right hazard warning lights where the shape of the illuminated region of the left light is altered to simultaneously indicate a left turn.

### DETAILED DESCRIPTION OF INVENTION

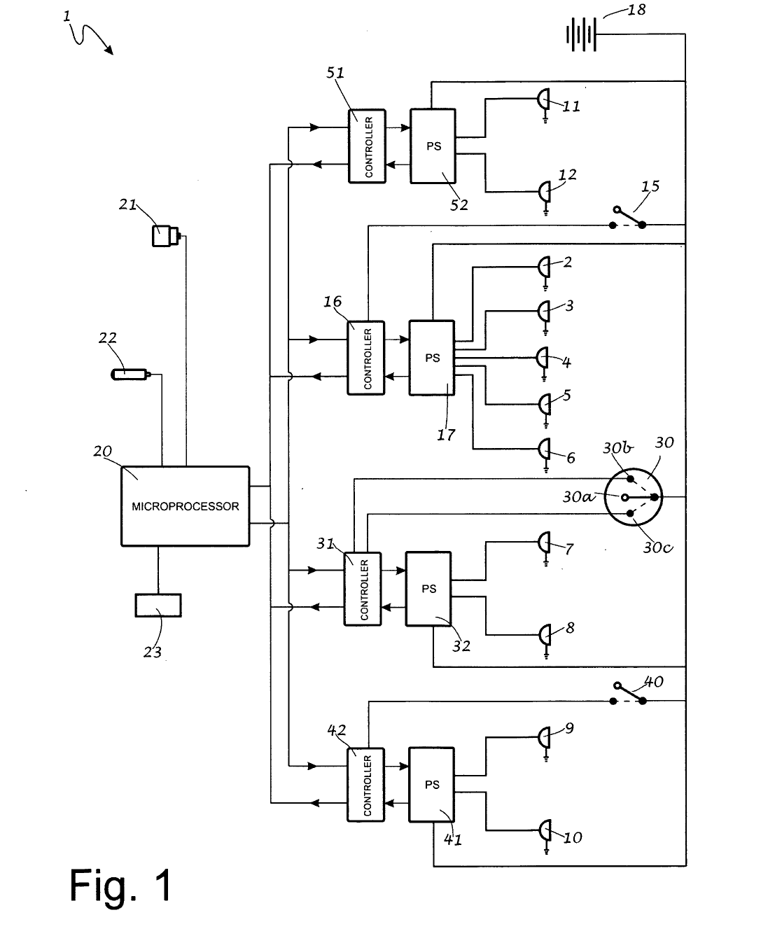

FIG. 1 shows a schematic of a lighting circuit 1 for controlling various vehicle lights such as, for example, several emergency and/or hazard warning lights 2, 3, 4, 5 and 6, turn signal lights 7 and 8, tail lights 9 and 10, and brake lights 11 and 12. These lights are preferably LED lights, but may be other types of lights suitable for automotive lighting. Each of lights 2-12 is comprised of at least one light source, such as, for example, a discrete LED or bulb filament. Two or more light sources performing the same or different functions may be consolidated into a single light fixture on a vehicle.

Emergency/hazard lights 2-6 may be, for example, the typically yellow hazard flashers of a private or commercial vehicle, or the typically blue or red emergency lights of a police car or an ambulance. When emergency light switch 15 is closed, the closure is detected by the emergency light controller 16. The controller commands the emergency light power supply 17 to direct electrical power from the vehicle electrical power source 18, such as, for example, a battery or a generator, to one or more of lights 2-6. The power supply 17 distributes the required power at the proper current or voltage to the lights 2-6 to achieve the desired illumination. The power supply may be commanded to activate the lights individually or in groups to produce constant illumination or synchronously or asynchronously flashing illumination at various flashing frequencies and wave forms, various colors, or duty cycles. Various other parameters such as, for example, on/off timing and the brightness of the lights may also be controlled by the controller 16. Controller 16 also communicates with microprocessor 20 that is configured to collect information from, for example, a brake sensor 21, an appropriately located ambient light sensor 22 or a navigation system 23. The microprocessor may also be configured with memory to store data about desired controller settings or rules of operation for various operating conditions. The brake sensor may be, for example, a position sensor that detects the motion of the brake pedal or a hydraulic sensor that detects the pressure in the brake system.

The turn signal switch 30 may be moved by the driver from neutral position 30a to left turn position 30b or right turn position 30c. When the turn signal switch is placed in the left turn or right turn position, it is detected by turn signal controller 31 which commands at least one left turn signal light 7 or at least one right turn signal light 8 to be flashed in order to indicate a turn. The flashing frequency, brightness, color and duty cycle of turn signal lights is determined by the power supply 32 as commanded by the controller based on stored information. Information may be stored in, for example, onboard memory of the microprocessor.

When tail light switch 40 is closed, power from the vehicle power source 18 is directed by power supply 41, under the control of the tail light controller 42, to tail lights 9 and 10. The controller 42 commands power supply 41 to achieve the required illumination of lights 9 and 10 based on predetermined settings for a given operating condition. Switch 40 may be a manual switch or an automated switch that is closed when ambient light levels are below a predetermined threshold.

When microprocessor 20 receives a signal from brake sensor switch 21 indicating that the brake pedal has been depressed, it communicates the information to controller 51. Controller 51 commands the brake light power supply 52 to direct the proper power from the vehicle power source 18 to brake lights 11 and 12 to achieve illumination at predetermined intensity and color. The brake lights may be held at constant brightness for the duration of the period when the brakes are applied or may be varied based on predetermined parameters for each operating condition and the output of various sensors. The brake lights are typically extinguished when the brakes are released.

The intensity or brightness of the illumination of the brake lights may be a predetermined function of, for example, ambient light conditions, as measured by ambient light sensor 22, or the location of the vehicle, as measured by the navigation system 23.

Alternatively, the brake lights may be activated automatically, for example, when the vehicle decelerates faster than at a predetermined rate or stops even if a signal is not received from sensor 21. This may be used as a failsafe system so that approaching drivers may be warned when the vehicle is slowing down, even if sensor 21 has failed. It may also be used to warn approaching vehicles that the vehicle has stopped due to a collision or is slowing due to a malfunction even if the brakes have not been applied and sensor 21 is therefore not activated. Under such circumstances, after a predetermined period has elapsed, the brake lights may be extinguished or their operation modified so that they operate as vehicle hazard warning lights.

Indication that the brake pedal has been applied may be supplied to several or all controllers. Time of day information, vehicle speed or location information may also be supplied to one or more controllers. Based on data from such sensors and stored information, one or more controllers may operate lights at a brightness, duty cycle or flashing frequency based on environmental conditions or vehicle operating parameters. For example, if the brake pedal is depressed so that the vehicle starts to decelerate at a rapid rate, all lights except the brake lights may be shut off for, for example, a 0.5 second period and then be gradually allowed to return to full brightness and predetermined frequency and duty cycle. Alternatively, the controller may shut off power to the emergency/hazard lights for a period of 0.5 seconds after the brakes are applied and then only allow limited power to flow when the light sensor indicates that ambient light conditions are such that the brightness of certain lights should be limited.

As a further alternative, other rear facing lights, such as backup lights or the emergency lights, may be used as brake lights or to augment brake lights. Such lights are illuminated in a similar manner as the brake lights when the brake pedal is depressed. For example, such other lights, as for example normally yellow or amber 4-way hazard flashers, when used as brake lights, may be illuminated with a steady red hue. Once the brake lights are extinguished, such other lights may be returned to their previous use.

One or more components in FIG. 1 may be combined into a single unit. For example, the microprocessor and one or more controllers may be configured as a single unit. A controller and corresponding power supply may also be configured as a single unit that performs the functions of both. Also, one or more of lights 2-12 may be combined in a single fixture.

U.S. Pat. Nos. 4,087,784; 5,808,545 and 7,408,455 describe vehicular signaling systems the contents of which are incorporated herein by reference in their entirety. U.S. Pat. No. 7,199,704 describes a vehicular flasher unit, with a controller that permits variable illumination schemes, the contents of which are incorporated herein by reference in their entirety. U.S. Pat. Nos. 6,674,624; 6,836,081; 6,987,787 and 7,332,877 describe various lighting systems with variable brightness, the contents of which are included herein by reference in their entirety. U.S. Pat. Nos. 7,489,089; 7,525,254; 7,566,142; and US patent applications 2005/0169015; 2010/0109375; 2010/0283407 and 2010/0321931 describe color variable lights, the contents of which are included herein by reference in their entirety.

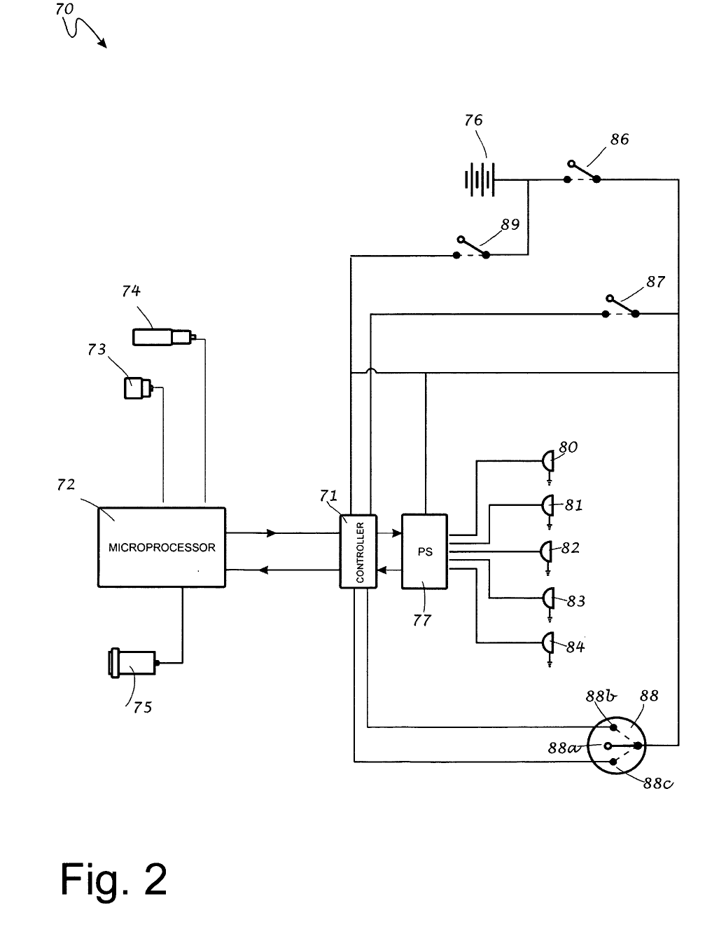

FIG. 2 shows a schematic of a vehicle lighting circuit 70 configured according to another embodiment of the invention. Controller 71 communicates with microprocessor 72 to receive data such as, for example, from a brake sensor 73 and a gear shift sensor 74. Controller 71 also commands the operation of power supply 77 that directs power from the vehicle's electrical power source 76 to multipurpose exterior lights 80, 81, 82, 83, and 84.

Switch 86 may be, for example, the ignition switch or other start-up switch of the vehicle. When switch 86 is closed, it connects the vehicle energy supply source, such as a battery, to tail light switch 87 and turn signal switch 88. The on position of the tail light switch is shown by a dashed line. The turn signal switch 88 has a neutral position 88a, a left turn position 88b and right turn position 88c.

Controller 71 may be programmed to command power supply 77 to direct the required power to lights 80 and 84 so that they may operate as the tail light of the vehicle, preferably producing red light, when switch 86 and switch 87 are closed. The brightness or intensity may be based on data stored in the memory of microprocessor 72 which specifies controller parameters for various operating conditions. These parameters may be a function of, for example, the level of light measured by ambient light sensor 75 and the positions of switches 87, 88 and 89.

When turn signal switch 88 is placed in left turn signal position 88b or right turn signal position 88c while main switch 86 is closed, controller 71 will detect the position of the switch 88 and command the controller to, for example, illuminate either light 81 or light 83 to indicate a left or right turn respectively. The lights may be flashed at a predetermined frequency and duty cycle. The color of illumination is preferably yellow or amber, but other colors may be selected by the controller. The intensity will be determined based on stored illumination rules that may be a function of, for example, available ambient light, vehicle speed or other vehicle operating or environmental parameters.

When hazard/emergency switch 89 is closed, it is detected by controller 71 which commands, for example, lights 80, 81, 83 and 84 to flash in yellow for private or commercial vehicles or in blue or red for emergency vehicles.

The operating parameters, such as, for example, flashing frequency, brightness and duty cycle, and color of each light are determined by the power supply as commanded by the controller. The intensity and color of the lights may be determined, for example, as a function of ambient lighting conditions, data stored in the microprocessor memory, the rate of slowing of the vehicle, the speed at the time the brakes are applied, whether the vehicle is traveling forward or backward and the pressure applied to the brake pedal. For example, if the system determines that the vehicle is in a dark tunnel, the intensity of the lights may be reduced so as not to overwhelm approaching drivers. On the other hand, if the vehicle is on a two lane desert highway in bright sunlight, the illumination of certain lights may be increased to maximum intensity.

When the brake sensor 73 indicates that the brake pedal has been depressed, the microprocessor conveys this information to the controller which commands the power supply 77 to illuminate, for example, lights 80, 81, 82, 83, and 84 in red to indicate that the vehicle is braking. The brake signal may be allowed to override signals from one or more switches 87, 88 and 89. For example, if lights 81 and 83 had been flashing in yellow or amber to indicate a hazard condition when the brakes were applied, their operation may be modified so that they are illuminated in steady red. Once the brakes are released, the lights may be returned to their previous operation as determined by the positions of switches 87, 88 and 89.

In a further embodiment according to the invention, if the vehicle is placed in reverse gear, several or all of the lights 80-84 may be made to operate as backup lights where they produce white light.

A priority tree may be established that determines how many lights will be dedicated to each function for any given operating or environmental condition. For example, all lights 80-84 may be used as red brake lights when the brake pedal is depressed. Alternatively, if the brake pedal is not depressed, all lights 80-84 may be used as emergency yellow or amber flashers if switch 89 is in a closed position. If both switches 88 and 89 are engaged, then two lights may be dedicated to emergency flashing while one is used as a turn signal.

By using various vehicle lights to serve multiple functions with proper illumination, each light is used more effectively and fewer total number of lights is necessary. Priority trees may be established for any number of vehicle lights so that all necessary functions are performed effectively and efficiently with the required number of lights being used for each task in the required manner.

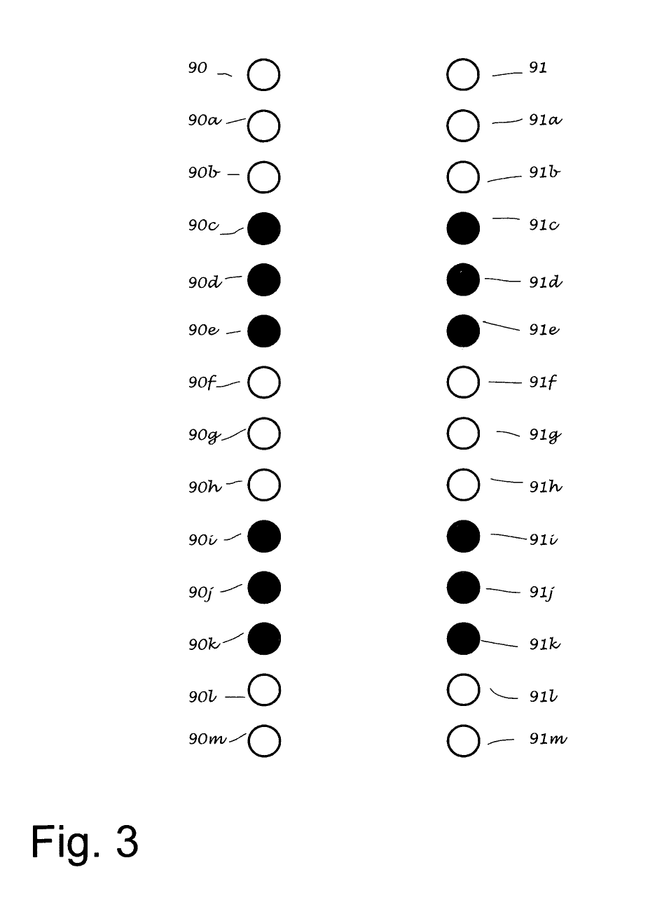

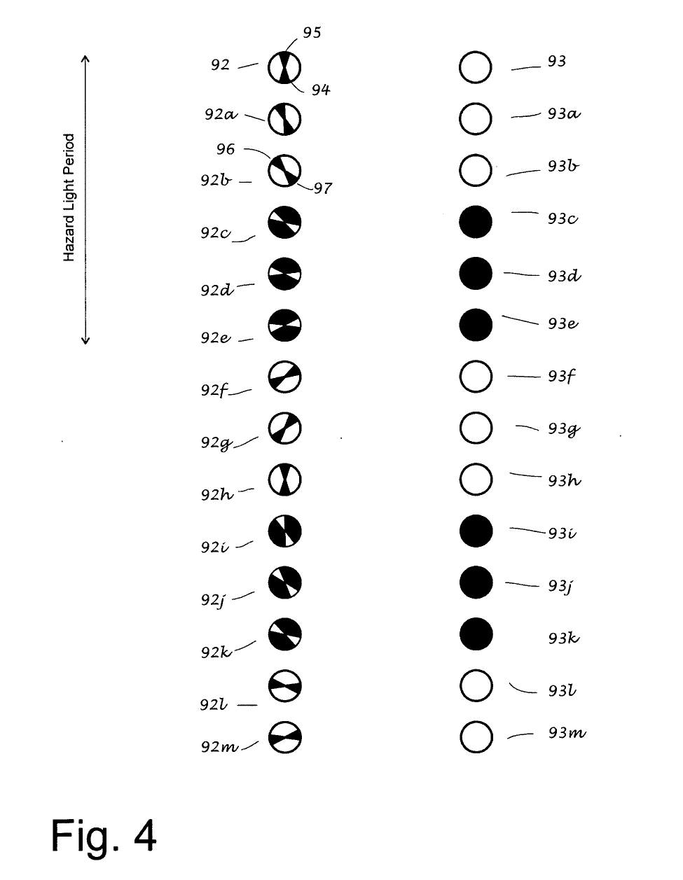

FIG. 3 is a schematic representation of two flashing circular hazard warning lights, one left 90 and one right 91. The time interval between each pair shown, for example, between 90 and 90a, represents one third of the time period during the cycle where the lights are on, and the time interval between 91c and 91d represents one third of the time period during the cycle where the lights are off. FIG. 4 is a schematic representation of two flashing circular hazard warning lights one left 92 and one right 93, flashing at the same frequency as the lights in FIG. 3. However, the shape of light 92 is altered so that during the on period of the cycle two wedge shaped areas 94 and 95 are not illuminated. These shapes rotate in the counterclockwise direction indicating a left turn signal. During the off portion of the hazard flashing period, light 92 is partially illuminated with wedge shapes 96 and 97 which continue to rotate in the counterclockwise direction.

In order to indicate a right turn, an equivalent wedge shape in the right light 93 would rotate in the clockwise direction (not shown).

Several embodiments have been described herein, some with reference to accompanying figures. These are intended to be illustrative. The following claims are not limited to or by the described illustrative embodiments, figures, and stated objects of the invention or the abstract. Furthermore, various presently unforeseen or unanticipated combinations of the disclosed embodiments, or their elements, or alternatives, variations or improvements which may become apparent to those of skill in the art are also intended to be encompassed by the following claims.

What is claimed is:

1) A vehicle comprising:
at least one signal light
a controller for illuminating said light with at least two different levels of brightness
a sensor for determining ambient light level
wherein the controller is configured to operate said emergency lights at one of said at least two brightness levels based on said ambient light level.

2) Vehicle as in claim 1, wherein said at least one signal light is an emergency light.
